(19) United States
(12) Patent Application Publication
(10) Pub. No.: US 2003/0163549 A1
(43) Pub. Date: Aug. 28, 2003

(54) Pre-paid CD-ROM for internet access

(76) Inventor: Aristides Franca Neto, Belo Horizonte (BR)

Correspondence Address: DICKINSON WRIGHT PLLC, Suite 800, 1901 L Street N.W., Washington, DC, 20036, US

(21) Appl. No.: 10/347,590

(22) Filed: Jan. 22, 2003

(30) Foreign Application Priority Data
Feb. 22, 2002 (BR) 00 0352

(51) Int. Cl. G06F 15/16; B42D 15/00

(52) U.S. Cl. 709/218; 283/117

(57) ABSTRACT

The present invention relates to a prepaid CD-ROM having a telephone number and access code which enables a user to connect to a global computer network via a designated internet service provider. Each code is assigned to an account with means for keeping track of the time left on the account. A protective cover, such as a peel-off strip or scratch-off paint, can be provided to conceal the code and/or telephone number so that unauthorized users will not be able to obtain access to the connection and account.

### FIELD OF THE INVENTION

The present invention relates to a pre-paid CD-ROM for internet access.

### BACKGROUND OF THE INVENTION

Prepaid telephone cards typically include toll-free telephone numbers and PINs (personal identification numbers) that can be used to access pre-paid long distance telephone services for a pre-set amount of time. The user in such case can dial the toll-free number from any telephone, and, by following the instructions on the card, i.e., entering the PIN, etc., long distance telephone calls can be made on a pre-paid basis, up to the time provided for on the card. The system that makes the connection keeps track of the time left on the card.

The internet is accessible by telephone via a dial-up modem or other connection on most computers. In such case, most internet service providers offer internet access services via the telephone line. Many such service providers, such as America Online, Compuserve, Earthlink, etc., offer unlimited usage for a fixed monthly fee, although some still charge by the hour or minute, based on the amount of time spent online. In either case, the user is typically required to register in advance so that an account can be opened in the user's name, and charges to the account can be paid through the user's financial account, such as a credit card. This may require, for example, the user to call the internet service provider, and provide a credit card number or other financial account information, to enable the service provider to collect the fees from the user.

Many of these internet service providers provide internet access software on CD-ROMS. For example, the service provider may send a mass-mailing of CD-ROMS with software to encourage people to subscribe to their internet service. They may also include CD-ROMS in magazines, with sales of computers, at counters at retail stores, inside packaging for other software, etc.

To date, no attempt has been made to provide internet services on a pre-paid basis, using CD-ROMs that include not only the software, but also an access code for accessing the internet, wherein a fixed amount of time has been allocated to the access code, such that the user that uses the access code can use the internet for the amount of time specified on the CD-ROM, which has been pre-paid by the user.

### SUMMARY OF THE INVENTION

The prepaid CD-ROM of the present invention is preferably a CD-ROM which contains the software program needed to connect to and access the internet, i.e., via the service provider that provided the CD-ROM. The CD-ROM preferably has an access code printed thereon (or on the packaging) which acts as a password for accessing the internet. The code is preferably pre-programmed and correlated with an account in the system that includes the amount of time purchased and allocated to that CD-ROM. This way, when a user purchases the CD-ROM, and uses the program and access code to dial up the internet, the system will enable the user to use the internet for the time specified on the CD-ROM, which has been pre-paid.

This allows the user to use the internet without having to register and open an account in advance. This also helps the user avoid having to provide any financial account information, such as a credit card number, to the service provider. In return, the service provider is given the benefit of obtaining full payment in advance.

The CD-ROM preferably includes information pertaining to how the user can connect to a global computer network, such as the “world wide web,” via a designated internet service provider working in connection with the issuance of the CD-ROM.

The CD-ROM and/or its packaging preferably contains the following:

1. Identification, such as name and logo, of the internet service provider.

2. The website of the internet service provider and/or other connective identification such as an email address.

3. The telephone number of the internet service provider, such as a toll-free number, that can be entered by the user to connect his or her computer to the global computer network via the internet service provider. This is preferably a toll free number assigned by the system which the user can enter into a computer terminal, wherein the computer can be instructed to be connected to the service provider's server, via the telephone line to which it is connected. This can be done by any computer that has installed thereon the software program provided in the CD-ROM that enables the computer to transmit the telephone number and connect to the service provider's server. The telephone number can also be provided on the software program for automatic dialing.

4. An access code (password or PIN), such as an alpha-numeric code, which identifies the user when the user attempts to connect to the internet service provider. This is a unique code that is pre-assigned to a particular CD-ROM, wherein when a user buys the CD-ROM and enters the code, the service provider's system recognizes the code and allows internet access to the user, depending on how much time is left on the account assigned to that code. The system preferably keeps track of the amount of time left on the account during the time that the computer is connected, and notifies the user when time is about to expire. The system preferably terminates the connection when time expires, but preferably allows more time to be added by paying an additional fee.

5. The value of the CD-ROM, i.e., the amount of time that is pre-paid, in the account assigned to the particular code. The CD-ROM can come with any predetermined amount of time or duration, and the price of the CD-ROM can be based on the amount of time provided on the CD-ROM.

6. A protective cover, such as a peel-off strip or scratch-off paint, which conceals the access code so that unauthorized users are not able to access the internet with the code. The buyer/user of the CD-ROM can reveal the code simply by removing the strip or scratching off the paint, but if the cover is damaged or otherwise removed without authorization, the buyer will preferably know that an unauthorized individual may have obtained access to the code. The user can then seek to have the CD-ROM replaced, or otherwise report it to the internet service provider.

### BRIEF DESCRIPTION OF THE DRAWINGS

FIG. 1 shows the CD-ROM of the present invention in its packaging; and

FIG. 2 shows the opposite side of the packaging.

### DETAILED DESCRIPTION OF THE INVENTION

The present invention relates to a CD-ROM which contains a software program that can be loaded into a user's computer, wherein access to the service provider's internet service can be provided for a predetermined amount of time via a telephone number and access code printed on the CD-ROM or its packaging. The CD-ROM preferably contains information relating to how the user can load the program and access the internet, wherein the amount of internet access time that the user has purchased is pre-programmed in the system, i.e., in connection with an account associated with the code. Accordingly, when a user logs on and accesses the internet using the code, the system will recognize the code, and allow internet access to the user for the amount of time specified on the CD-ROM. When time expires, the user will be notified, and/or access will be terminated, and/or the user will be given an opportunity to add time to the account.

In the preferred embodiment, a telephone number is provided on the CD-ROM (or its packaging), such as a toll-free number, as well as an access code that relates to the account that has been pre-assigned to that CD-ROM. The telephone number could also be included in the software program instead of on the packaging. The access code is the password that the user uses to access the internet.

In the preferred embodiment, the access code is printed on the packaging and has a protective peel-off strip or scratch-off paint covering the code, which can be removed by the purchaser of the CD-ROM. The strip or paint is preferably designed so that any tampering by an unauthorized user will be self-evident, so that the purchaser will know when someone has unlawfully obtained the access code.

The information on the CD-ROM, as well as instructions for its use, can be printed on the CD-ROM, on a label affixed to the CD-ROM, or on the packaging in which the CD-ROM is contained. Additional space for providing advertising and other information on the CD-ROM or its packaging can also be provided, wherein the service provider can include its own advertising, or sell space on the CD-ROM or its packaging to other businesses that want to advertise using the CD-ROM. Additional information, such as spaces for product partnerships, UPS numbers, bar codes, serial numbers, email addresses, telephone numbers, access codes, passwords, etc., can also be provided.

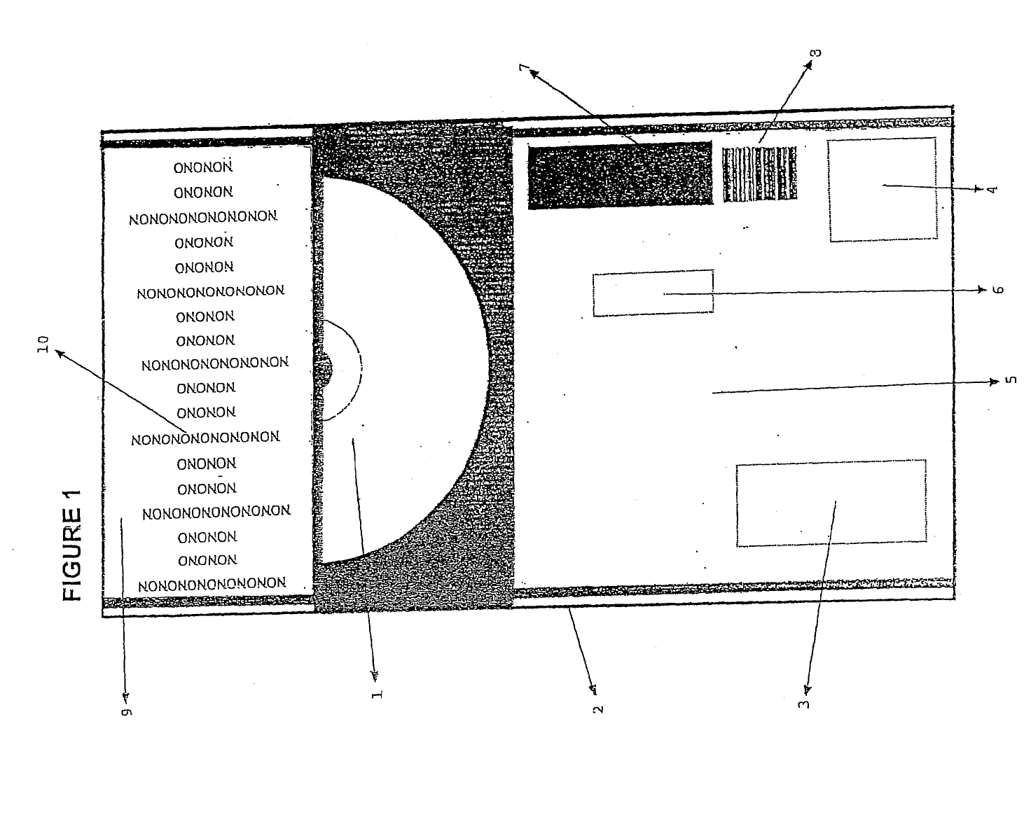

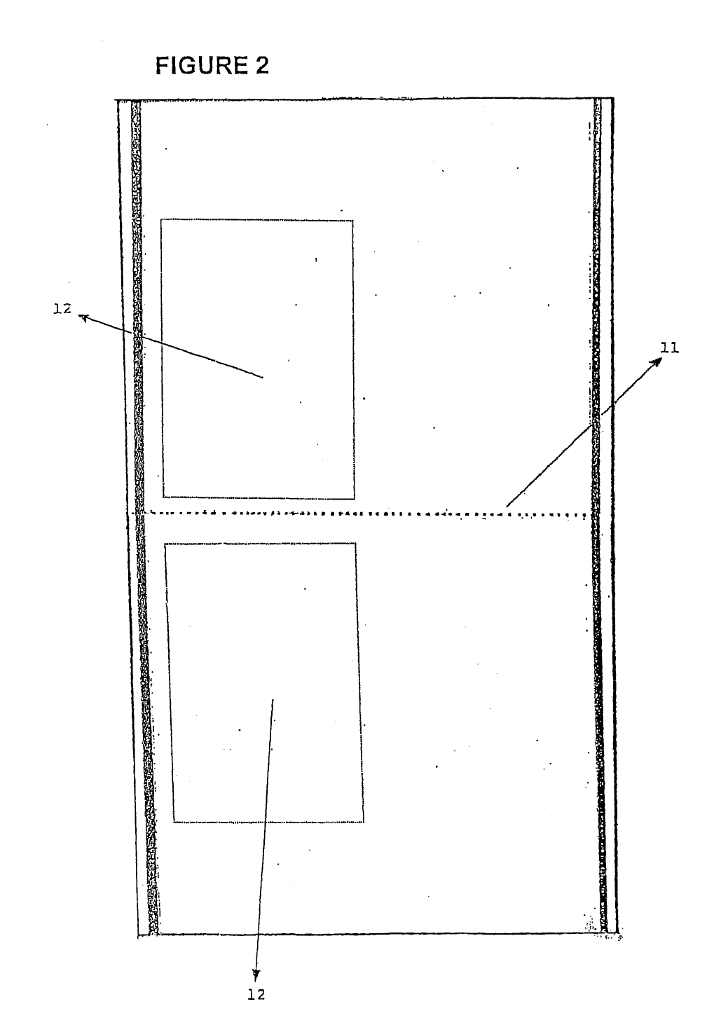

In FIGS. 1 and 2, the CD-ROM 1 of the present invention is shown in packaging 2 in a conventional manner. Various written or printed information can be provided on the CD-ROM 1 or its packaging 2. For example, the packaging 2 can be provided with a space for providing an identifying logo 3, a specific field for identifying and disclosing commercial partners and operators 4, and electronic addresses and other information 5. Another space for the pre-paid value and time 6 on the CD-ROM that the buyer has paid for can be printed thereon. The access code, which is preferably hidden behind a peel-off strip 7, or scratch off paint, or other means of covering the printed information, can also be provided. The strip 7 or other cover can be used to cover the access code and/or telephone number. Additional spaces 8 for providing serial numbers and bar codes, etc., can also be provided. The printed insert 9 can have additional space 10 for providing a list, such as examples of states, municipalities, countries, etc., of the covered areas. On the back side of the packaging 2, there can be a fold 11, as well as additional spaces 12, on which other information, such as advertisements and other data, can be provided.

The above items are intended to represent examples of the various types of information that can be provided. They are not intended to be limiting in any manner, such as with regard to where or how the information is shown or provided.

In use, the internet service provider may offer CD-ROMs with various amounts of time on them. For example, the provider may offer a predetermined number of minutes or hours of internet time on the CD-ROM for a predetermined price, i.e., 30 hours for $15.00, etc. The user who wants to use the CD-ROM would then buy the CD-ROM with the quantity that he or she wants. The user would then take the CD-ROM and download the operating software into his or her computer, wherein the CD-ROM or its packaging would contain all of the information needed for the user to connect to and access the internet, via a telephone number and access code specific to that CD-ROM.

The system would then identify the CD-ROM (through recognition of the access code) that was used to access the internet, wherein information relating to that account would be recalled by the system. This allows the system to call up how much access time has been purchased in connection with the access code, and enable it to monitor the length of time that the user uses the internet, wherein at the appropriate time, the system could notify the user how much time is left in the account, and/or shut off access to the internet. The system could also provide a means for allowing more time to be added to the account, if desired.

The CD-ROM is intended to enable any user that buys the CD-ROM, and that has a computer, such as a desk-top terminal, laptop, PDA, etc., with a modem connected to a telephone line, to access the internet. The CD-ROM preferably contains the appropriate software program that can be installed to run the program and enable the telephone number to be entered and transmitted to the designated internet service provider to make the connection. Such a program is often provided with the purchase of a computer, but can also be provided by the CD-ROM.

A different access code is preferably printed on each CD-ROM or its packaging, and each code is preferably assigned to a different account in the system, with a predetermined amount of time allocated to each account, such that with every CD-ROM that is purchased, the user will be entitled to a fixed amount of time in the account. As the user uses the system, a time keeping means is preferably provided to keep track of the amount of time left on each account, such that the system can notify the user when time in the account is about to expire. It preferably terminates the internet connection when time does expire. Preferably, the system enables the user to add time to the account, i.e., by adding money to the account, which can be done through entries made to the system via a credit card or the like.

The CD-ROM preferably enables a user to become registered to connect to the internet without having to go through the steps of calling and filling out forms to become a registered member. Since the CD-ROM is pre-paid, no further information regarding the user and his or her financial ability to pay is needed. Also, since each CD-ROM is assigned a different code, there is no need to identify the user by name, and, since each code accesses a different account, each account can be metered independently. Lastly, the toll-free telephone number will enable any user from any location to become connected without any further telephone charges.

The CD-ROM can be used for advertising and has commercial value in that sense. That is, advertisements can be printed on the CD-ROM or its packaging, such that when a user uses the CD-ROM, he or she will see the advertising. Additional information can be provided on the back of the packaging. Not all of the information on the CD-ROM discussed above are required. Only the access code, and the telephone number if not provided in the software, are essential. The value of the CD-ROM and name of the provider are preferaby provided.

The CD-ROM can be made of any conventional material. The printing or application of information can be by any conventional means, and the peel-off strip or scratch-off paint can be applied in any conventional manner. A peel-off strip can be used, although it may be more difficult to tell if the strip is removed and replaced. Other information, such as a bar code, or advertising or decoration, can also be printed on the CD-ROM.

The CD-ROM and/or its packaging preferably contains the following:

1. Identification, such as name and logo, of the designated internet service provider company, shown as (3).

2. Additional identification, such as name and logo, of any affiliated company, i.e., a telephone company, shown as (4).

3. The website and/or other connective identification of the internet service provider, such as an email address, shown as (5).

4. The telephone number of the internet connection, which is preferably a toll-free number (shown covered by the strip 7). This is the telephone number used by the user to connect to the global computer network via the internet service provider. This number is preferably entered into a computer terminal, wherein the computer's software enables the computer to be connected to the service provider's server via the telephone line. This can be done by any computer that has software installed that enables the computer to transmit the telephone number and connect to the service provider's server.

5. Additional information or advertisements, shown as (8).

6. The value of the CD-ROM, shown as (6). This is the amount of time that is pre-paid on the CD-ROM assigned to the account that corresponds to the code. The CD-ROM can come with any amount or duration, such as 30 minutes, 60 minutes, 350 minutes, etc., on the account. The price of the CD-ROM preferably corresponds with the amount of time on the CD-ROM.

7. An access code (password or PIN), such as an alpha-numeric code, shown as being covered by strip (7), which identifies the user when the user attempts to connect his or her computer to the internet service provider's server. This is a code that is pre-assigned to a particular CD-ROM, wherein when a user buys the CD-ROM and enters the code at the appropriate time, the internet service provider system recognizes the code and allows internet access to the user depending on how much time is left in the account assigned to that code. The system preferably keeps track of the amount of time left on the account, and notifies the user when time is about to expire. The system preferably terminates the connection when time expires.

8. A protective cover, such as a peel-off strip or scratch-off paint, shown as (7), which conceals the access code is preferably provided so that unauthorized users are not able to access the code needed to connect to the internet service provider. The buyer/user of the CD-ROM can reveal the code to make the connection by peeling off the strip or scratching off the paint, but if the cover is damaged or otherwise removed, the buyer will know that an unauthorized individual could have obtained the code. The user can then seek to have the CD-ROM replaced, or otherwise report it to the internet service provider. The protective cover can also be adapted to cover other information on the card, as necessary, such as the toll-free telephone number.

In the claims:

1. A pre-paid CD-ROM comprising packaging with information on the CD-ROM and/or its packaging, comprising:
a first portion having a telephone number thereon capable of being used to connect a computer to an internet service provider via a telephone connection and a global computer network;
a second portion having a code thereon, wherein said code can be used as a password for enabling said computer to be connected to said global computer network, and have access to an account associated with said code having a predetermined amount of time allocated thereto; and
a third portion indicating the amount of time that has been allocated to said account, wherein the internet service provider enables a user of the CD-ROM to obtain access to the internet service provider for the amount of time allocated to said account.

2. The CD-ROM of claim 1, wherein said CD-ROM has a fourth portion with information regarding the internet service provider, and a fifth portion with connective identification.

3. The CD-ROM of claim 2, wherein said connective identification is a website or email address of the internet service provider.

4. The CD-ROM of claim 1, wherein a removable protective cover is provided to conceal the information on said first and/or second portions.

5. The CD-ROM of claim 4, wherein said protective cover is comprised of scratch-off paint or other scratch-off material.

6. The CD-ROM of claim 4, wherein said protective cover is comprised of a peel-off strip.

7. The CD-ROM of claim 1, wherein one or more removable protective covers are provided to conceal the information on said first and/or second portions.

8. The CD-ROM of claim 1, wherein said telephone number is a toll-free number.

9. The CD-ROM of claim 1, wherein said code comprises alpha-numeric symbols.

10. The CD-ROM of claim 1, wherein said code is assigned to an account, wherein the time allocated to the account determines how long the computer can remain connected to said global computer network.

11. The CD-ROM of claim 10, wherein the user is notified in advance at a predetermined time before the connection is terminated of when the connection will be terminated and/or that additional time can be added to the account before the connection is terminated.

12. A CD-ROM comprising packaging with information on the CD-ROM and/or its packaging, comprising:
a first portion having an access code thereon capable of being used to connect a computer to an internet service provider via a telephone connection and a global computer network, wherein said code can be used as a password for enabling said computer to be connected to said global computer network, and have access to an account associated with said code; and
wherein one or more removable protective covers are provided to conceal the information on said first portion.

13. The CD-ROM of claim 12, wherein said one or more protective covers is comprised of scratch-off paint or other scratch-off material.

14. The CD-ROM of claim 12, wherein said one or more protective covers is comprised of a peel-off strip.

15. The CD-ROM of claim 12, wherein a predetermined amount of time has been allocated to said account, and wherein the time allocated to said account determines how long the computer can remain connected to said global computer network before the connection is terminated.

16. The CD-ROM of claim 15, wherein the user is notified in advance at a predetermined time before the connection is terminated of when the connection will be terminated and/or that additional time can be added to the account before the connection is terminated.

17. A method of providing a CD-ROM to connect to a global computer network, comprising:
providing a CD-ROM comprising packaging with a telephone number and access code on the CD-ROM and/or its packaging;
enabling a computer to be used to enter the telephone number and code to connect to said global computer network and access an account associated with said code;
allocating a predetermined amount of time on said account; and
enabling said computer to be connected to said global computer network for said predetermined amount of time, wherein said connection is adapted to be terminated at the expiration of said amount of time.

18. The method of claim 17, wherein the user is notified in advance at a predetermined time before the connection is terminated of when the connection will be terminated, and/or that additional time can be added to the account before the connection is terminated.

19. The method of claim 17, wherein said predetermined amount of time allocated to said account can be adjusted.
